(19) United States
(12) Patent Application Publication
(10) Pub. No.: US 2006/0116121 A1
(43) Pub. Date: Jun. 1, 2006

(54) Communication system between a mobile phone and a telephone/data switching system which allows the mobile phone to be an extension of this telephone/data switching system

(76) Inventor: Teresa Maria de Andrade Rosado, Lisboa (PT)

Correspondence Address: BIRCH STEWART KOLASCH & BIRCH, PO BOX 747, FALLS CHURCH, VA, 22040-0747, US

(21) Appl. No.: 10/529,864

(22) PCT Filed: Oct. 1, 2003
(86) PCT No.: PCT/PT03/00013

§ 371 Date: Oct. 18, 2005

(30) Foreign Application Priority Data
Oct. 2, 2002 (PT) 102846

(51) Int. Cl. H04Q 7/20

(52) U.S. Cl. 455/428

(57) ABSTRACT

The present invention refers to a communication system between a mobile phone and a PABX, which allows any programmable mobile phone to work as a PABX extension, being the PABX responsible for answering, making and transferring phone calls, as well as detection, identification and integration of mobile phones, and also a PABX installed software which allows to perform those functions.

The scope of the present invention is inserted in the telecommunication domain and refers in particular to a communication system between a mobile phone and a telephone/data switching system, which allows the mobile phone to be an extension of this telephone/data switching system.

### BACKGROUND OF THE INVENTION

The increase of telecommunication traffic made it necessary to improve the switching capacity of PABX. However, with the present state-of-art, PABX only has fixed extensions or DECT, PHS technology or equivalent. PABX does not have extensions, which use, as a transmission line, other wireless telecommunication networks. Thus, according to the previous state-of-art, a PABX is established as following:
CPU, Central Processing Unit with RAM and ROM
Power supply with or without external battery
Electric current stabilizer with protection against variations
Digital switching matrix (anti-blocking or not anti-blocking; TDM or IP)
Network circuits
   ISDN Basic Rate Interface (BRI) access
   ISDN Primary Rate Interface (PRI) access
   xDSL access
   Internet Protocol (IP) access
   DTMF analogue access
   Decadic analogue access
   20 PPS analogue access
Other system interface circuits
   E&M analogue interface
   QSIG digital interface
   Proprietary digital interface
Extension circuits
   Decadic analogue extension circuits
   20 PPS analogue extension circuits
   DTMF analogue extension circuits
   ISDN Basic Rate Interface (BRI) extension circuits
   Proprietary digital extension circuits
   DECT/PHS wireless extension circuits
Emergency circuits
Remote diagnostic and remote programming systems
DTMF generator and detector and suspension music
Extensions direct access circuits and remote control module
C.T.I. supporting circuits
Extern commands optional package, door-phone and others

Note: PABX can have access to radio communications, through the network circuits, just by connecting to the network circuit through a transmitter according the specific technical characteristics.

PABX services, features and characteristics, which were used in the previous technique, are listed below:
Personal programming ability
Ability to answer and transfer any phone call to any extension
Ability to make outside phone calls from any extension
Extension ability to communicate between each other
Phone calls routing and redirecting system
voice mail services
Computer and telephone system integration
Remote support, remote programming and remote diagnostic
Specific functions for organizations, business companies, hotels, call centres and telemarketing
Traffic statistic analysis
Messages broadcast
Phone calls restraint
Access codes
Multiple class of service
Caller identification
Informative messages
Phone calls pre-answer
Available services at analogue and ISDN public switching network

At the present time, a PABX, which has, telephone networks integration and connection to other system, has also extensions (analogue or digital), which do not use as a transmission line any other system. However this invention uses an independent radio system between PABX and the mobile phone as a transmission line. This independent radio system can be GSM, UMTS, satellite, TDMA, CDMA, AMPS, NAMPS, ETACS or any other kind radio transmission.

Surprisingly, the inventor noticed that it was possible to establish a communication system between a mobile phone and a PABX, which allows any programmable mobile phone to work as a PABX extension with the resort of PABX software, and made the invention communication system.

At the eighties, there were systems which allowed the connection to the PABX with DISA software, even through analogue lines, and with the recourse to the DTMF for sending commands and line signal detection to allow the communication disconnect identification. In publication US 2002/00192646 it is described a system which includes an intermediate unit (stated as wireless communication unit), IU, and a PABX. This unit allows any wired or wireless telephone to connect to the PABX, since the IU makes the connection between the PSTN and the PABX via a PRI circuit. However, the PRI circuit does not allow all kinds of signalling that the PABX offers and receives from fixed extensions. This invention exceeds this limitation, by introducing a transmitter into the PABX. The PABX and its components will be fully responsible for the integration. As also stated in the previous publication, the integration uses the PSTN between the mobile extension and the PABX, which brings disadvantages in costs of the exploited system. Our invention improves it, allowing the transmission line to be a circuit of the mobile network of the mobile phone, making the connection one-network oriented. As stated, all components of the intermediate unit (IU) are present in the PABX (CPU, receiving and transmitting circuits and a database). The intermediate machine will have to be configured with the same database that a PABX has, concerning the users restriction and permission tables, as well as receiving and transmitting the signalling, which a fixed PABX extension requires. Thus, problems as inconsistency of both PABX and intermediate unit databases can occur. Long delays can happen in the processing of two machines in one communication. Huge costs in the investment and maintenance of two systems with redundant components and spreading of information (the mobile phone extension data in IU database and fixed extension data in database). Either this data redundancy, or signalling limitations, as well as enormous disadvantages in costs with phone calls in business media, can be solved with our invention that uses one only network in communication and reversible circuits. These circuits make the identification of the mobile extension and switch from trunk circuit to extension circuit as the integration is allowed by the PABX CPU.

There are no use of any type of server components, nor the existence of any messages exchange between the systems that do not exist in a normal communication system between the fixed extension and the PABX. The fixed network dependence is null, as only the radio communication system is used, without any special programming in the mobile network operator, which makes this invention a key of a better and cheaper business communication.

### DETAILED DESCRIPTION OF THE INVENTION

The present invention refers to a communication system between a mobile phone and a PABX, which allows any programmable mobile phone to work as a PABX extension. The PABX execute the answer, making and transfer call functions, as well as detection, identification and integration of mobile phones. Mobile phones also have access to PABX software, which allows these functions development.

Attached, schematic figures for better comprehension of this communication system are presented, wherein:

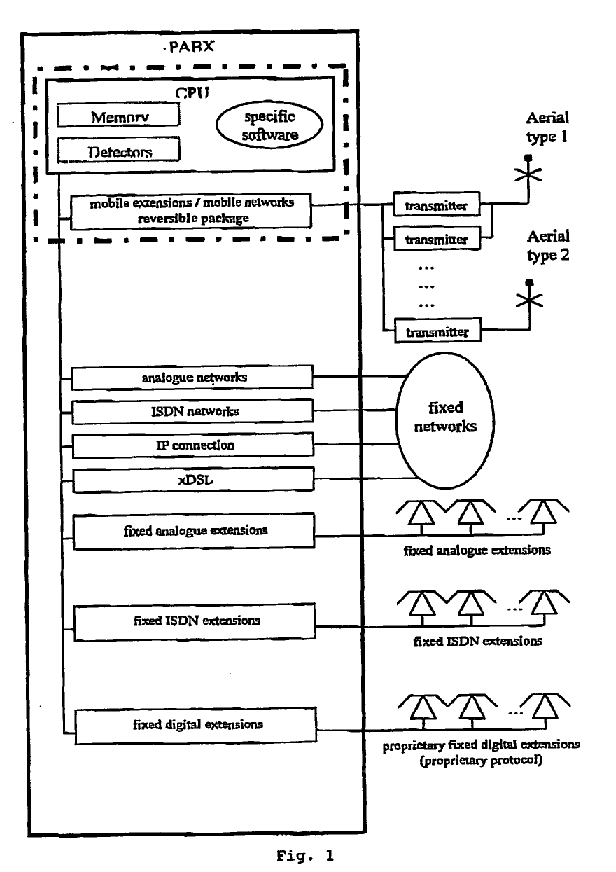

FIG. 1 represents a PABX invention scheme.

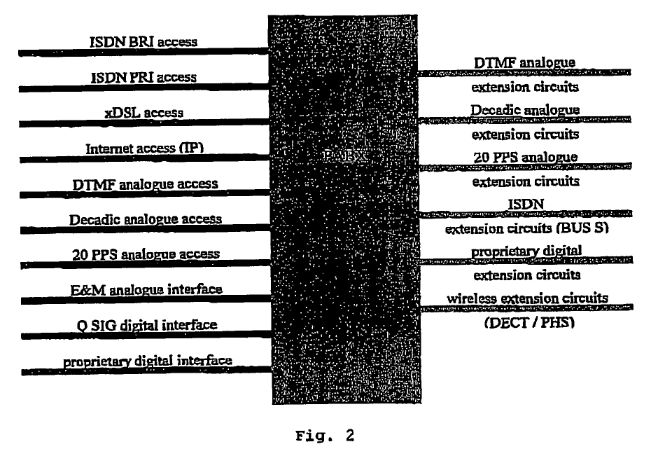

FIG. 2 represents the closest prior art PABX circuits, interface and access scheme.

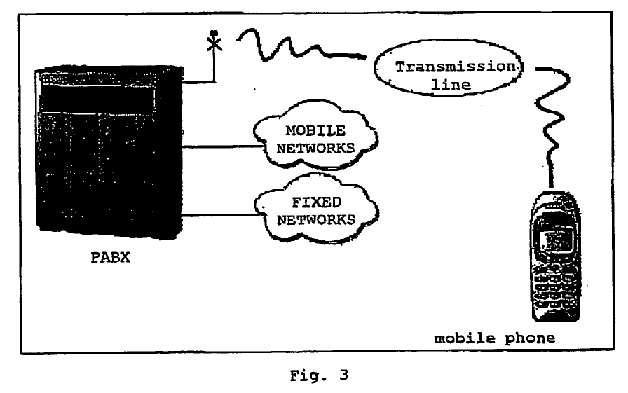

FIG. 3 illustrates the invention communication system functioning principle.

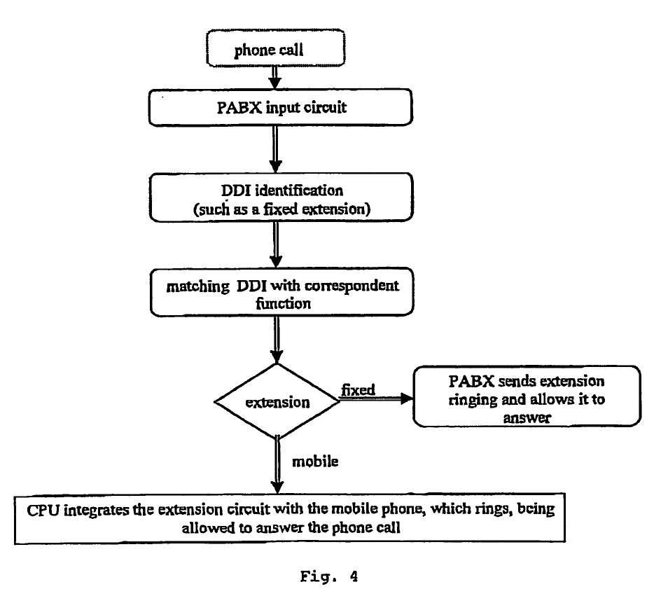

FIG. 4 shows the diagram in case of a phone call PABX reception coming directly from the exterior.

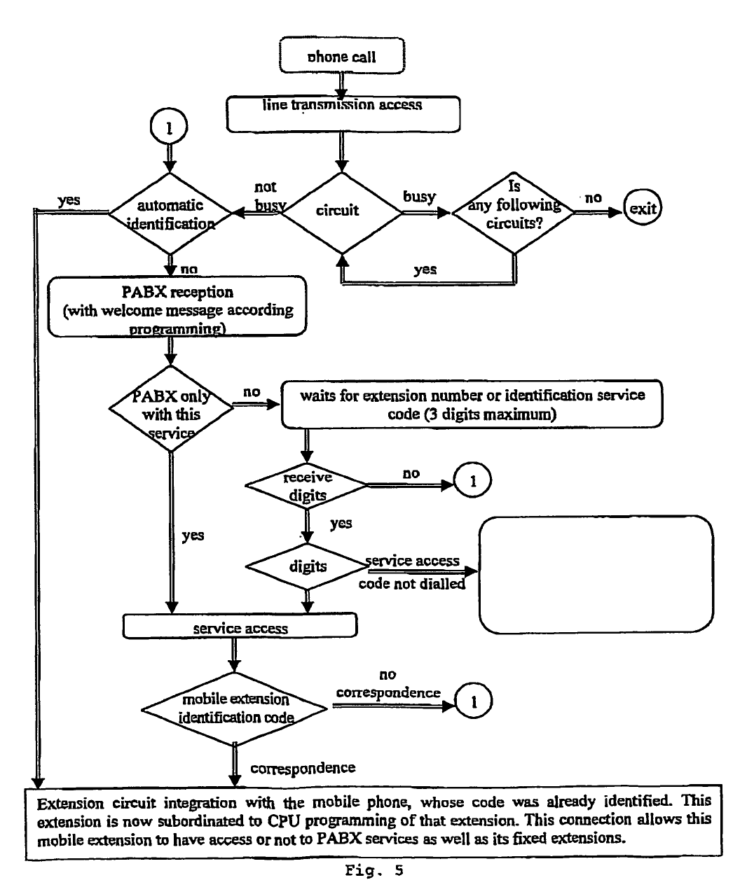

FIG. 5 shows the diagram in case of a phone call made through the mobile phone.

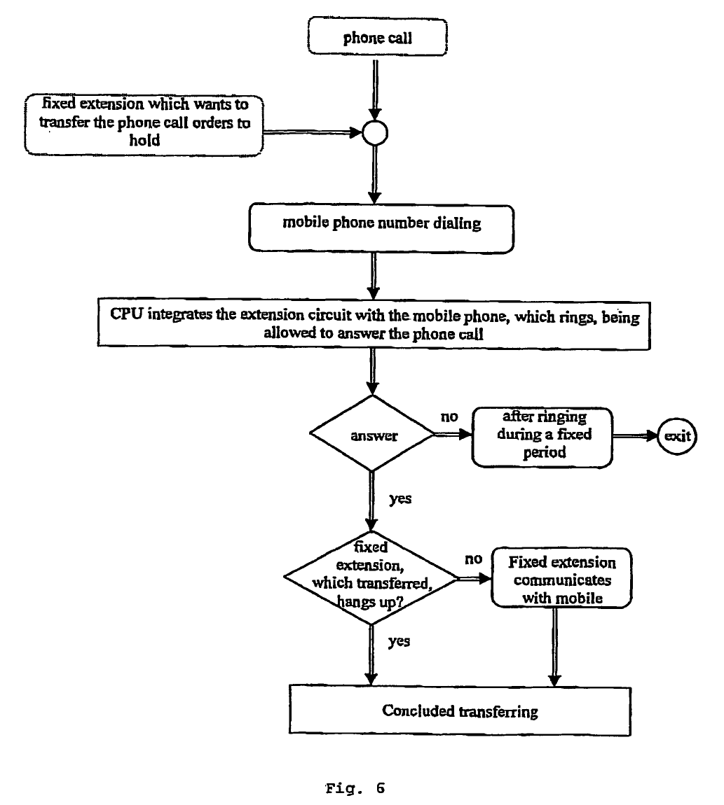

FIG. 6 shows the diagram in case of a PABX transfer call to a mobile phone.

From now on, the following features of this invention communication system will be described in detail using abbreviations defined at the end of the Description: the constitutive elements, the necessary conditions of each constitutive element, the electronic circuits used in the making of this invention, the functions made by this invention system and the functioning principle.

3.1. Constitutive Elements

The constitutive elements are described below;

3.1.1. PABX

A PABX has the numbers of mobile and fixed telephone network circuits, mobile and fixed telephone networks extensions according to the specific needs. The mobile transmitter circuit integrated in the PABX must be compatible with the mobile phone configuration.

3.1.2. Transmission Line

The transmission line must be compatible with mobile extension configuration. This transmission line can be a point-to-point radio circuit, a trunking radio net, GSM, UMTS, TDMA, CDMA, AMPS, NAMPS, ETACS, satellite or any kind of radio communication. The transmission line must be compatible with the mobile phone configuration. According to the mobile phone, it is possible to choose the transmission line and the transmitter used in PABX.

3.1.3. Mobile Phone

The mobile phone can be known as cell phone, radiophone, satellite phone, mobile extension or cell extension. In this project when we introduce mobile phone we refer to any of these names.

The mobile phone is chosen according to the local and communication demands. The mobile phone can be any which work with GSM, UMTS, TDMA, CDMA, AMPS, NAMPS, ETACS or any other cell network, satellite or any other radio communication.

Any kind of mobile phone is compatible by changing PABX transmitter module according to the mobile phone used.

3.2. Constitutive Elements Obligatory Conditions

3.2.1. PABX

3.2.1.1. The number of network lines must be according to the required mobile and fixed telephone networks direct access.

3.2.1.2. The number of internal extension must be according to the specific needs.

3.2.1.3. The number of PABX transmitters must be according to the mobile extensions needed for simultaneous communication. PABX transmitters characteristics must be according to the chosen mobile phone characteristics. PABX can have any kind of transmitters, with different characteristics, since it has connected mobile phones with different characteristics. In other words, it can have at the same time different mobile extensions like GSM, UMTS, TDMA, CDMA, AMPS, NAMPS, ETACS, satellite and any kind of radio communicators.

3.2.1.4. Detection circuits to identify mobile phones after the communication establishment. These circuits are both able to identify the caller before the audio communication is established, and after the communication is established, they can receive an identification code.

3.2.1.4.1. Detection made by identifying the mobile phone caller. PABX has this service available only for the mobile network technology, which also has this service.

3.2.1.4.2 Detection made by a code sent by the mobile phone after the audio communication establishment. The PABX has this service to identify those mobile extensions whose technology does not support caller identification before answering. These detectors are also available to enforce security even if the technology is able to send a mobile phone caller identification. Those detectors are frequently DTMF detectors, however they can use any other kind of transmission signalling.

3.2.1.5. CPU

PABX has a CPU where proper software to the following functions development is located: answering and making phone calls, transferring, specific functions, detection, identification and mobile phone integration.

3.2.1.6. Power Supply Circuits

PABX has the required power supply circuits to feed all its components and peripheral devices.

3.2.2. Transmission Line

Transmission line means the communication means used to established the communication between PABX and the mobile extension. There are several types of transmission line according to the mobile phone.

The only item required is the compatibility between the mobile phone and the PABX transmitter. The transmission line can be any of the following systems; GSM, UMTS, TDMA, CDMA, AMPS, NAMPS, ETACS, satellite, specific radio frequency transmission or any other kind of radio transmission.

3.2.3. Mobile Phone

Any mobile phone can work as a PABX mobile extension. The only item required is the agreement between the mobile phone and the PABX transmission characteristics and the existent transmission line.

3.3. Electronic Systems Used in the Embodiments of the Invention

This invention is based on the principle from now on described, with different power supply circuits, network and extension packages, processing unit, etc. Thus, in this invention we are not interested in the electronic circuits but in their integration with the detectors, identifier systems, transmission line and proper software to the mobile extension.
PABX power supply circuit
PABX CPU with proper software and mobile extension identification detector
Analogue internal extension package
Digital internal extension package
Convertible ISDN internal extension package for each gate through ISDN basic access circuits programming
Convertible PRI ISDN package through E1, T1 and QSIG programming
Decadic system analogue network package convertible to DTMF
IP package with IP access
Cell system transmitters and antennas. These elements can be GSM, UMTS, TDMA, CDMA, AMPS, NAMPS, ETACS, satellite, specific radio frequency transmission systems or any other kind of radio transmission system.

The present invention can be either integrated in a PABX or built in an independent cabinet and connected with an existent PABX. In this case, the independent cabinet should have all the circuits, which precedes this invention beginning with transmitters, identifiers circuits, as well as coupling circuits between the cabinet, which contains this invention, and a PABX. This coupling can be either done through the PABX extension, junction or network circuits (even through IP network) or connecting directly through the CPU. Here not all coupling ways will be described, since they are reachable by any technician who entirely understands this invention's previous technology.

3—4 Invention System Function

3.4.1. Function of Mobile Phone as an Extension

This function allows a mobile phone to receive phone calls from a PABX as well as to access to all PABX function variety as if it was an internal extension, though being able to use other system as transmission line. One advantage is that the functioning cover is that one permitted by the transmission line between PABX and the mobile phone.

The transmission line used can be the own cell network (such as GSM or other system), satellite or through radio communication between PABX and the mobile phone. The mobile phone and the transmitter/receptor PABX will be chosen according to the transmission line.

A mobile phone can be programmed as an extension of one or more PABX.

3.4.2. Phone Calls Transfer

3.4.2.1. Concerning external phone calls transfer, received or made by the PABX.

The PABX extension mobile phone function allows a mobile phone to receive by transfer any phone call coming from its own PABX. Thus, making or receiving an external phone call, any internal extension or PABX operator is able to suspend the phone call and transfer it to the mobile phone. That phone call can be made to or coming from fixed and mobile access networks.

Procedure:

When an internal extension is communicating with the exterior:
1—Press the hold-on button
2—Dial the mobile phone extension number
3—It is able to disconnect and the communication will be automatically transferred to the mobile phone.

Note: this procedure can be made differently according to the phone model, which transfers the phone call.

3.4.2.2. Concerning internal phone calls transfer, received or made by PABX.

Any extension, which receives a phone call from a fixed extension or from an extension mobile phone, is able to suspend and transfer it to any other extension phone call from the system. In case a fixed extension made by that phone call to another fixed extension or to an extension mobile phone, the proceeding extension is able to suspend and transfer that phone call to any extension mobile phone.

Procedure:

When an internal extension is communicating with other internal extension or with an extension mobile phone:
1—Press the hold-on button
2—dial the mobile phone extension number
3—it is able to disconnect and the communication will be automatically transferred to the mobile phone.

Note: this procedure can be made differently according to the phone model, which transfers the phone call.

3.4.2.3. Concerning an internal or external phone call transfer, received or made by the mobile phone extension.

Mobile phone extensions are able to suspend the received or made phone calls (internal or external), to dial a code, which holds, and then transfer it not only to any internal extension but also to other mobile phone extension or to the exterior.

Procedure:

When the mobile phone extension is communicating:
1—dial the hold code
2—dial the number which will receive the phone call
3—it is able to disconnect and the communication will be automatically transferred to the mobile phone.

Note: this procedure can be made differently according to the mobile phone model, which transfers the phone call. In other words, instead of dialling the hold-on code, the mobile phone model may have a pre-memorized hold code button. If that mobile phone model does not send any signal during the communication, it is not able to transfer phone calls. However, that mobile phone is able to send or to receive any phone call and it has access to the other PABX services.

3.4.3. Phone Calls Made by Mobile Phone Extension

Whenever the mobile phone extension is asked to make a phone call, a digit is pressed and a communication with PABX is established (this can happen through a restricted users group if the transmission line is a cell network). Since the communication has been established, the mobile phone extension will automatically send an identification code, which will be processed by the CPU. From this point, the PABX is able to integrate the mobile phone extension, and this last one is logically connected to the PABX as an internal extension. The mobile phone extension is now able to dial an internal number if the communication is internal to the PABX, or to dial an external number if the communication is to the exterior, to the fixed or mobile access networks. If a phone call is made in these conditions the communications are established by the PABX available access networks. In case the PABX is equipped with a smart system to trace the least cost route, the given access network line and the operator will be the most suitable. Calls made by the mobile phone extension can be made by the PABX through the fixed access network or through the mobile access network circuits or others if the PABX is so equipped.

This invention is also able to perform other services as combined with previous functions, normally existent in PABX. That is the case of call back function, which being associated with this invention, builds another service. Thus, if PABX configures the call back function, as the mobile phone is identified, instead of receiving the PABX condition to be able to dial, the PABX disconnects and processes call back, which is to explain that the PABX establishes a connection through the PABX to the mobile phone. In this case, it is the PABX, which establishes the communication to the mobile phone through the transmission line between both elements, and non-inversely, which in some circumstances can be cost effective. Associating the call back function with this invention, the PABX is the one that returns the communication to the mobile phone, giving to the mobile phone the possibility to communicate to any location. The call back function, which until now was used by PABX, for internal services, and by telephone operators to switch tariffs, is now, with the present invention, applied to mobile transmission lines belonging to autonomous systems. With the present invention, the call back function builds another service.

Procedure;
1—press a mobile phone digit (this digit can have a number or command memory in order to establish a transmission line to the PABX and must have the identification code).
   or
   in case there is not a memory available at the mobile phone for this effect a number/command and the identification code must be dialled manually.
      or
   in case the mobile phone has the software which allows a determined beforehand prefix and pause, the user only needs to dial the final destiny call number, since the mobile phone will automatically do the procedure 1, 2 and 3,
2—once the transmission line is established the mobile phone is informed that it is integrated into the system, it can also be done by a voice signal: “you are integrated into the sytem”
3—the mobile phone is able to dial an internal or external number according to the intended phone call. Then the phone call will be established.

3.4.4. Phone Calls Received by the Mobile Phone Extension

The phone calls can be received by five different ways;
directly from the exterior through the mobile phone number (in case the mobile phone extension is integrated into a public mobile access network)
directly from the exterior through the number of the PABX with the number of the mobile phone extension added
through the PABX answering and the followed transfer to the mobile phone
directly from a fixed internal extension or other mobile phone extension
directly from the exterior through a DDI as like as any other fixed PABX extension

3.4.4.1. Phone Calls Directly Received from the Exterior Through a Mobile Phone Number (in Case the Mobile Phone Extension is a Public Cell Access Network)

If the mobile phone extension is able to receive direct calls from the public cell access network or satellite, it is also able to receive any direct phone call without needing to pass through the PABX. In this case, the mobile phone extension has an internal number but also a public phone number.

Procedure:

Any mobile or fixed public access network telephone, which wants to communicate with a mobile phone extension, must proceed the following way:
1—dial the mobile phone extension public number (including area code if required) and then the phone call will be established as it happens in other ordinary phone.

3.4.9.2. Phone calls directly received from the exterior through a PABX number with the mobile phone extension number added.

The PABX can have fixed or mobile access network lines aimed to automatically answer phone calls and forward them to the extension. This way, any public phone can call these numbers where an automatic answer will be processed and then dial the wanted extension number.

Procedure;

People who intend to connect the extension mobile phone this way must know the PABX line number, which is used to process automatic answering, and the extension mobile phone number.
1—dial the PABX line number which is used process automatic answering (since the connection is established it is possible to hear “please dial the extension number”).
2—Dial the mobile phone extension number and the mobile phone will automatically ring.

3.4.4—3. Phone calls received with a PABX answering service and posterior transfer to the mobile phone.

As shown in 1.2.1. (concerning external phone calls transfer, received or made by the PABX).

3.4.4.4. Directly received phone calls from a fixed internal extension or from other extension mobile phone.

Any fixed or mobile extension is able to communicate with the extension mobile phone. Dialling the number is the only thing that is necessary.

Procedure:
1-dialling the extension number

3.5. Invention Communication System Applications

There is a variety of applications of this mobile phone extension invention. The applications can be in business companies, hotels, public services, and private residences, etc.

A PABX can be used everywhere, also the mobile phone extension can be a useful service.

Mobile extensions are able to receive or make phone calls through the PABX. Hence, if the PABX has fixed and mobile access networks from multiple operator, the mobile extension is able to make any phone call through the destiny operator avoiding the need of having an operator making the connection between different networks.

At the phone calls reception, the extension mobile phone is also able to receive any kind of communication transferred through the PABX, independently of the operator source. In this case it is also unnecessary an operator for the interface between multiple operators, since the PABX avoids it.

The extension mobile phone only has the services allowed by the PABX. Thus, each mobile extension is able to have a personalized programming which will authorize in a selective way to make only internal, locale regional, national, international phone calls, or to other mobile networks, or to specific numbers.

With the mobile extension service any PABX is able to make complete and integrated management of all extensions either fixed or mobile phones.

Any extension mobile phone can have a double service of being an extension of a PABX but also have a direct network to make and receive phone calls, regarding the necessary services.

A mobile phone can also be programmed as an extension of one or more PABX. In this case, it is possible to choose the PABX which will do the requested phone call.

3.6 Functioning Principle

The functioning principle is based on the following items:

3.6.1. When a mobile phone receives a PABX phone call.

In this situation, when a PABX connects or transfers a phone call to the mobile phone, it is the PABX that dials the mobile extension number. Thus, the identification of the relative mobile extension with the number is automatically done. This way the PABX connects to the mobile phone, transfers the phone call as well as the CPU is informed about this situation. The CPU, rendering this way the system integration, automatically does the mobile extension allocation to the PABX extension circuit. Therefore, after receiving a phone call, the mobile phone will have an integrated communication circuit with the PABX as if it was a fixed internal extension. The only difference is the different transmission line used.

3.6.2. When the mobile phone makes a phone call.

Previously, the mobile phone establishes a communication with the PABX. The PABX has receiving circuits of that communication prepared to identify the caller before establishing the audio connection, or after establishing the audio connection and receiving a caller identification code. That code can be a DTMF signal or others. As the CPU is informed about the caller identification, the mobile extension acknowledgment with the corresponding number is done. The CPU will automatically allocate that transmission line with the mobile extension from the belonging extension circuit, since the PABX has a relation between the extension number and the identification number.

By this way the mobile extension is connected to the PABX extension circuit as it happens with any fixed extension. The only difference is that the fixed phone is permanently connected to the PABX, while the mobile phone extension is connected after the communication is established and the mobile phone is identified.

In this project the integration's moment happens when the mobile phone allocation to the PABX extension circuit is done, after the communication is established and the mobile phone identification.

After the integration the mobile phone is able to make phone calls and have access to the PABX services as any internal extension, having the authorized PABX permissions to that extension.

Summarizing, whenever the mobile phone is receiving or making a phone call, a previously communication with the PABX is established. The PABX identifies that mobile phone and makes the integration. Once the integration is done, the mobile phone will work as any PABX fixed extension and submitted to a personalized programming according with the extension number.

4 Final Note

This invention provides a communication system wherein a PABX is able to manage fixed and mobile phones in its extensions. Hence, the mobile and fixed phones are able to be totally traffic controlled by the PABX software, when making or receiving any connection. The PABX software is also included in the scope of the invention. The invention is based in the PABX integration with the mobile phone by using the proper software and identification detectors.

The description was made with help of specific implementation formulas, which should not be considered as restrictive but illustrative, being the ambit defined by the attached claims.

### ABBREVIATION DEFINITION

PAMX—Private Automatic Branch Exchange
CPU—Central Processing Unit
RAM—Random Access Memory
ROM—Read-Only Memory
ISDN—Integrated Services Digital Network
BRI—Basic Rate Interface, ISDN access, 2B+D (channels: 2×64 kbp+16 kbps)
PRI—Primary Rate Interface, ISDN access. In the USA, 23B+D (channels: 23×64 kbps+64 kbps); in Europe, 30B+D (channels: 30×64 kbps+64 kbps)
DTMF—Dual-Tone Multifrequency
DISA—Direct Inward System Access
DECT—Digital Enhanced Cordless Telecommunications
PHS—Personal Handyphone System
xDSL—Digital Subscriber Line—family of DSL technologies. The “x” in xDSL stands for any number of letters denoting the xDSL family members such as asymmetric DSL (ADSL), high-bit-rate DSL (HDSL), ISDN DSL (IDSL), single-pair symmetrical services DSL (SDSL), very high-data-rate DSL (VDSL)
IP—Internet Protocol
LAN—Local Area Network
DDI—Direct Dialing In
E&M—Ear (Receive) and Mouth (Transmit)
QSIG—Q SIGnalling
C.T.I.—Computer Telephony Integration
GSM—Group Special Mobile (Global System for Mobile Communications)
UMTS—Universal Mobile Telecommunications System
TDMA—Time Division Multiple Access
CDMA—Code Division Multiple Access
AMPS—Advanced Mobile Phone Service
NAMPS—Narrow AMPS
ETACS—Extended Total Access Communication System

1. A communication system between a mobile phone and a PABX, characterized in that it allows any programmable mobile phone to connect and communicate as a PABX extension, making and receiving phone calls, as well as accessing all services of the referred PABX, as an internal extension of the referred PABX, with the referred PABX communicating with the referred mobile phone directly through the mobile network, the communication's transmission line between the referred mobile phone and the referred PABX is established by accessing mobile networks and without needing to access fixed networks of the following type: PSTN, ISDN, IP or direct lines.

2. System according to claim 1, characterized in that the communication's transmission line between a mobile phone and a PABX is a cellular oriented communication like GSM, UMTS, TDMA, CDMA, AMPS, NAMPS, ETACS and others.

3. System according to claim 1, characterized in that the communication's transmission line between a mobile phone and a PABX is a satellite communication.

4. System according to claim 1, characterized in that the communication's transmission line between a mobile phone and a PABX is a radio communication, trunking, UHF, VHF and other frequencies allowed by each country's law.

5. System according to the previous claims 1 to 4, characterized in that it allows transferring calls received by PABX either from fixed or from mobile telephone networks.

6. System according to claims 1 to 4, characterized in that it allows the transfer of phone calls made from PABX either from fixed or from mobile telephone networks.

7. System according to claim 1, characterized in that it allows the mobile phone to have also access to PABX authorized services.

8. System according to claim 1, characterized in that it comprises a PABX, a programmable mobile phone compatible with the PABX installed transmitter and a transmission line also compatible with the PABX installed transmitter.

9. System according to claim 8, characterized in that the PABX has fixed and mobile network circuits and fixed and mobile extension circuits.

10. System according to claim 8, characterized in that the PABX has one or more transmitters as GSM, UMTS, TDMA, CDMA, AMPS, NAMPS, ETACS, or a transmission by satellite, or a different frequency transmitters according to the country's law at the moment of communication.

11. System according to claim 8, characterized in that the mobile phone is compatible with the PABX installed transmitter, as GSM, UMTS, TDMA, CDMA, AMPS, NAMPS, ETACS, or a transmission by satellite, or other, according to the PABX installed system.

12. System according to claim 8, characterized in that the transmission line is compatible with the PABX installed transmitter, thus, comprising a GSM, UMTS, TDMA, CDMA, AMPS, NAMPS or ETACS transmitter or a satellite transmitter, or others, according to the PABX installed system.

13. System according to claim 10, characterized in that the PABX comprises detection circuits to identify the mobile phone after the communication establishment.

14. System according to claim 13, characterized in that the mentioned identification is made by a code sent through the mobile phone.

15. System according to claim 13, characterized in that the mentioned identification is done automatically.

16. System according to claims 10 to 15, characterized in that it allows the referenced mobile phone to be recognized by more than one PABX.

17. System according to claim 10, characterized in that the PABX comprises a central processing unit, CPU, which has a system functions developed software, namely answering, making and transferring phone calls, and detecting, identifying and integrating mobile phones.

18. PABX, which comprises the system according to claim 1.

19. PABX according to claim 18, characterized in that its installed reversible package is able, at any time of work, by CPU orders, to switch the network function with extension.

20. Software integrated in the PABX CPU according to claim 18, characterized in that it allows the system function development, namely answering, making and transferring phone calls, and detecting, identifying and integrating mobile phones.

21. Software according to claim 20, characterized in that it allows to control the mobile phone identification through system detectors and after making that identification, to charge that mobile phone with an extension number which corresponds to the mobile phone identification in the CPU memory.

22. Software according to claims 20 to 21, characterized in that it is capable to order a PABX reversible package so that the communication channel which is being used by the mobile phone, switch from network to extension.

23. Software according to claim 20, characterized in that it is capable to program vary logical extension number according to the existent mobile phone numbers.

24. Software according to claim 20, characterized in that it is capable to charge, bound PABX accesses or services to mobile phone extensions as PABX proceeds with fixed extensions.

25. Software integrated in the PABX CPU according to claim 20, characterized in that the function procedure of answering, making and transferring phone calls from PABX to a mobile phone, is done as described in the attached Figures.
